(19) United States
(12) Patent Application Publication
(10) Pub. No.: US 2025/0387915 A1
(43) Pub. Date: Dec. 25, 2025

(54) SYSTEMS AND METHOD FOR SAFE ACTUATION OF A MOBILE ROBOT

(71) Applicant: Boston Dynamics, Inc., Waltham, MA (US)

(72) Inventors: Devin Billings, Waltham, MA (US); Kyle W. Rogers, Carlisle, MA (US); Michael Murphy, Carlisle, MA (US)

(21) Appl. No.: 19/243,861

(22) Filed: Jun. 20, 2025

Related U.S. Application Data
(60) Provisional application No. 63/663,823, filed on Jun. 25, 2024.

(51) Int. Cl. B25J 9/16; B25J 19/00

(52) U.S. Cl. CPC B25J 9/1674; B25J 9/161; B25J 19/0025

(57) ABSTRACT

A robot configured to operate safely in response to detecting an abnormal operating condition is provided. The robot includes an actuator coupled to a robot member and a motor controller configured to control the actuator to move the robot member about a robot joint. The motor controller includes a first set of components and a second set of components, and each of the first set of components and the second set of components is independently operable by the motor controller to control the actuator to move the robot member about the robot joint.

### RELATED APPLICATIONS

This application claims the benefit under 35 U.S.C. § 119 (e) to U.S. Provisional Patent Application No. 63/663,823, filed Jun. 25, 2024, and titled, “SYSTEMS AND METHOD FOR SAFE ACTUATION OF A MOBILE ROBOT,” the entire contents of which is incorporated by reference herein.

### TECHNICAL FIELD

This disclosure relates generally to robotics and more specifically to systems and methods for providing safe actuation in robots.

### BACKGROUND

A robot is generally defined as a reprogrammable and multifunctional manipulator designed to move material, parts, tools, and/or specialized devices through variable programmed motions to perform one or more tasks. Robots may be manipulators that are physically anchored (e.g., industrial robotic arms), mobile platforms that move throughout an environment (e.g., using legs, wheels, or traction-based mechanisms), or some combination of one or more manipulators and/or one or more mobile platforms. Robots are utilized in a variety of industries including, for example, manufacturing, warehouse logistics, transportation, hazardous environments, exploration, and healthcare.

### SUMMARY

Certain kinds of mobile robots (e.g., legged robots) may pose hazards to nearby people and/or property if they lose control of their joints during operation. For example, for legged robots that practice dynamic balancing during locomotion (e.g., walking or trotting), abnormal operating conditions that impact robot joints (e.g., faults, such as power outages, integrated circuit failures, wire breaks, etc.) may cause such robots to lose control of their bodies (e.g., fall or crash to the ground) if they suddenly lose their ability to balance dynamically. Accordingly, systems and methods for maintaining the ability to balance dynamically when such abnormal operating conditions occur may make legged robots safer to be around during operation.

Some embodiments herein include systems and methods for powering and/or controlling movements of robotic actuators to reach a safe state in the event of an abnormal operating condition, such as an electrical fault, short, loss of power, or other operational failure condition of a robot.

Power, control, and/or other electronic modules may be compartmentalized into two or more independently functional (e.g., redundant) units (e.g., two functional units per robot joint), such that failure of one unit does not necessarily imply failure of any other unit. In some embodiments, the actuation hardware for a particular robot structure (e.g., a single robot joint) may be divided into two or more “fractional” or smaller, compartmentalized actuation assemblies (e.g., two approximately equal “half” actuation assemblies, such that an actuation assembly may provide half of the maximum torque during normal operation), also referred to herein as “motor assemblies” or simply “assemblies.” As a result, if one fractional actuation assembly fails due to any single abnormal operating condition, a complementary actuation assembly may still maintain enough power and a reliable control signal, which can be used to implement a “safe stop” command for the larger robot structure (e.g., gently rotating the joint) and/or the robot as a whole (e.g., gently lying down, or another form of controlled stopping).

In some embodiments, the actuation hardware may be configured to isolate a portion, subset, or partition of the total power source(s) for powering the actuation hardware, such that an abnormal operating condition affecting the portion, subset, or partition of the total power source(s) does not impact the operation of the other portions of the actuation hardware.

In some embodiments, movements (e.g., trajectories) of robot joints operated using the actuation hardware may be periodically or continuously stored. Upon occurrence of an abnormal operating condition, the stored robot joint trajectories may be used to identify one or more actions to be performed by the actuation hardware to control the robot joints that enables the robot to reach a safe state.

Some embodiments of the present disclosure include systems and methods for facilitating a safe fall of a robot or robot joints in the event of a total loss of power to the robot or robot joints. For example, some joints of the robot may be configured to spin freely whereas other joints of the robot may be configured to be damped (e.g., passively damped), which may cause the slowing of the movement of the joints in the event of a total loss of power to the robot or robot joint.

In some embodiments, the invention features an actuator. The actuator includes a housing, a first motor assembly at least partially disposed within the housing, the first motor assembly electrically connected to a first power lead and a first control data interface, and a second motor assembly at least partially disposed within the housing, the second motor assembly electrically connected to a second power lead and a second control data interface. The first motor assembly and the second motor assembly are each independently operable to drive movement of the actuator.

In one aspect, the first power lead is electrically connected to a first power source and the second power lead is electrically connected to a second power source, the first power source separate from the second power source. In another aspect, the actuator further includes at least one first switch configured to isolate the first power source from the first motor assembly in response to detecting an abnormal operating condition affecting the first motor assembly, and at least one second switch configured to isolate the second power source from the second motor assembly in response to detecting an abnormal operating condition affecting the second motor assembly. In another aspect, the first power source is electrically connected to a first power bus and the second power source is electrically connected to a second power bus, the first power bus separate from the second power bus.

In another aspect, at least one of the first power lead or the first control data interface is electrically connected to a first wiring interconnect, and at least one of the second power lead or the second control data interface is electrically connected to a second wiring interconnect. In another aspect, the first wiring interconnect is a first slip ring, and the second wiring interconnect is a second slip ring.

In another aspect, the first control data interface is electrically connected to a first control circuit and the second control data interface is electrically connected to a second control circuit, the first control circuit separate from the second control circuit. In another aspect, the first motor assembly comprises a first commutation encoder and the second motor assembly comprises a second commutation encoder. In another aspect, the first motor assembly is electrically connected to a first motor drive system and the second motor assembly is electrically connected to a second motor drive system. In another aspect, the actuator further includes a first switching device electrically connected to the first motor assembly and a second switching device electrically connected to the second motor assembly, the first switching device is configured to disconnect the first motor assembly from the first motor drive system when an abnormal operating condition affecting the first motor assembly is detected, and the second switching device is configured to disconnect the second motor assembly from the second motor drive system when an abnormal operating condition affecting the second motor assembly is detected.

In another aspect, the first motor assembly comprises a first stator and the second motor assembly comprises a second stator, the first stator and the second stator sharing a common axis. In another aspect, the first motor assembly comprises a first set of windings and the second motor assembly comprises a second set of windings, the first set of windings interleaved with the second set of windings around a common axis. In another aspect, the first set of windings and the second set of windings operate as a 6-phase motor, the first set of windings is configured to operate as a 3-phase motor in response to a detected abnormal operating condition affecting the second motor assembly, and the second set of windings is configured to operate as a 3-phase motor in response to a detected abnormal operating condition affecting the first motor assembly.

In another aspect, the actuator is configured to implement a safe stop using only the first motor assembly when an abnormal operating condition affecting the second motor assembly is detected. In another aspect, the first motor assembly and the second motor assembly are operably connected to a common drive shaft. In another aspect, the first motor assembly and the second motor assembly are operably connected to a robot joint. In another aspect, the robot joint is configured to spin freely when an abnormal operating condition affecting at least one of the first motor assembly or the second motor assembly is detected. In another aspect, the robot joint is configured to spin freely for a first time period after the abnormal operating condition is detected and/or be slowed during a second time period after the first time period. In another aspect, the robot joint comprises a knee joint of a biped robot. In another aspect, the robot joint includes a viscoelastic material, and a movement of the robot joint is configured to be slowed based on the viscoelastic material in response to detecting an abnormal operating condition affecting at least one of the first motor assembly or the second motor assembly.

In some embodiments, the invention features a robot. The robot includes an actuator operably connected to a robot joint, and at least one processor. The at least one processor is configured to determine a trajectory of the robot joint, based on the trajectory, determine an action to be performed for the robot joint to reach a safe state, store the trajectory in association with the action in a storage, in response to detection of an abnormal operating condition affecting an operation of the robot, control the actuator to operate the robot joint in accordance with the action to reach the safe state.

In one aspect, the storage is associated with the robot joint, and wherein storing the trajectory in association with the action in the storage comprises sending the trajectory and the action to the storage associated with the robot joint. In another aspect, the at least one processor includes a first processor and a second processor, the first processor being configured to determine the trajectory of the robot joint, and the second processor being configured to control the actuator to operate the robot joint in accordance with the action to reach the safe state. In another aspect, the actuator includes a housing, a first motor assembly at least partially disposed within the housing, the first motor assembly electrically connected to a first power lead and a first control data interface, and a second motor assembly at least partially disposed within the housing, the second motor assembly electrically connected to a second power lead and a second control data interface, wherein the first motor assembly and the second motor assembly are each independently operable to drive movement of the actuator, and detection of an abnormal operating condition affecting an operation of the robot includes an abnormal operating condition affecting the first motor assembly or the second motor assembly. In another aspect, the robot further includes first power switching circuitry associated with a portion of the robot that includes the robot joint, and the at least one processor is further configured to operate the first power switching circuitry to electrically isolate the portion of the robot in response to the detection of an abnormal operating condition affecting an operation of the robot. In another aspect, the robot further includes a set of power switching circuitry including the first power switching circuitry, wherein each power switching circuitry in the set of power switching circuitry is configured to electrically isolate a different portion of the robot in response to the detection of an abnormal operating condition affecting an operation of the robot within its corresponding portion.

In some embodiments, the invention features a robot. The robot includes an actuator coupled to a robot member and a motor controller. The motor controller is configured to control the actuator to move the robot member about a robot joint, wherein the motor controller includes a first communication interface configured to receive one or more first control commands for controlling an operation of the actuator and a second communication interface configured to receive one or more second control commands for controlling an operation of the actuator when an abnormal operating condition is detected that affects communication via the first communication interface.

In one aspect, at least one of the first communication interface or the second communication interface is configured to receive the one or more first control commands and the one or more second control commands wirelessly.

In some embodiments, the invention features a robot. The robot includes an actuator coupled to a robot member and a motor controller configured to control the actuator to move the robot member about a robot joint, wherein the motor controller includes a first set of components and a second set of components, and each of the first set of components and the second set of components is independently operable by the motor controller to control the actuator to move the robot member about the robot joint.

In one aspect, the first set of components includes a duplicate set of components included in the second set of components. In another aspect, the first set of components includes a first component is configured to perform a first operation, and the second set of components includes a second component configured to perform a second operation when an abnormal operating condition is detected that affects the first operation when performed by the first component. In another aspect, the first set of components includes a first communication interface configured to receive one or more first control commands, and the second set of components includes a second communication interface configured receive one or more second control commands when an abnormal operating condition is detected that affects communication via the first communication interface.

In another aspect, at least one of the first communication interface or the second communication interface is configured to receive the one or more first control commands and the one or more second control commands wirelessly. In another aspect, the first set of components includes a first power source, and the second set of components includes a second power source, the first power source being separate from the second power source. In another aspect, the first set of components includes a first component configured to isolate the first power source from the first set of components in response to detection of an abnormal operating condition affecting the first power source, and the second set of components includes a second component configured to isolate the second power source from the second set of components in response to detection of an abnormal operating condition affecting the second power source. In another aspect, the first power source is electrically connected to a first power bus and the second power source is electrically connected to a second power bus, the first power bus separate from the second power bus.

In another aspect, the first set of components includes a first control data interface, and the second set of components includes a second control data interface. In another aspect, the first control data interface is electrically connected to a first wiring interconnect, and the second control data interface is electrically connected to a second wiring interconnect. In another aspect, the first wiring interconnect is a first slip ring, and the second wiring interconnect is a second slip ring. In another aspect, the first control data interface is electrically connected to a first control circuit and the second control data interface is electrically connected to a second control circuit, the first control circuit separate from the second control circuit.

In another aspect, the first set of components comprises a first commutation encoder and the second set of components comprises a second commutation encoder. In another aspect, the first set of components is electrically connected to a first motor drive system and the second set of components is electrically connected to a second motor drive system. In another aspect, the motor controller is configured to implement a safe stop using only the first set of components when an abnormal operating condition affecting the second set of components is detected. In another aspect, the first set of components and the second set of components are operably connected to a common drive shaft. In another aspect, the robot joint is configured to spin freely when an abnormal operating condition affecting at least one of the first set of components or the second set of components is detected. In another aspect, the robot joint is configured to spin freely for a first time period after the abnormal operating condition is detected and/or be slowed during a second time period after the first time period. In another aspect, the robot joint comprises a knee joint. In another aspect, the robot further includes first power switching circuitry associated with a portion of the robot that includes the robot joint, and at least one processor configured to operate the first power switching circuitry to electrically isolate the portion of the robot in response to detecting an abnormal operating condition affecting at least one of the first set of components or the second set of components. In another aspect, the robot further includes a set of power switching circuitry including the first power switching circuitry, wherein each power switching circuitry in the set of power switching circuitry is configured to electrically isolate a different portion of the robot in response to detecting an abnormal operating condition affecting an operation of the robot within its corresponding portion. In another aspect, the robot joint includes a viscoelastic material, and a movement of the robot joint is configured to be slowed based on the viscoelastic material in response to detecting an abnormal operating condition affecting at least one of the first set of components or the second set of components.

In some embodiments, the invention features a method. The method includes driving movement of an actuator using a first motor assembly and a second motor assembly, wherein the first motor assembly is at least partially disposed within in a housing, the first motor assembly is electrically connected to a first power lead and a first control data interface, the second motor assembly is at least partially disposed within the housing, the second motor assembly is electrically connected to a second power lead and a second control data interface, and each of the first motor assembly and the second motor assembly is independently operable to drive the movement of the actuator.

In one aspect, the method further comprises controlling at least one first switch to isolate a first power source from the first motor assembly in response to detecting an abnormal operating condition affecting the first motor assembly, and controlling at least one second switch to isolate a second power source from the second motor assembly in response to detecting an abnormal operating condition affecting the second motor assembly, wherein the first power source is separate from the second power source. In another aspect, the first motor assembly is electrically connected to a first motor drive system and the second motor assembly is electrically connected to a second motor drive system, and the method further includes disconnecting the first motor assembly from the first motor drive system when an abnormal operating condition affecting the first motor assembly is detected, and disconnecting the second motor assembly from the second motor drive system when an abnormal operating condition affecting the second motor assembly is detected.

In another aspect, the first motor assembly comprises a first set of windings and the second motor assembly comprises a second set of windings, the first set of windings interleaved with the second set of windings around a common axis, and the method further includes operating the first set of windings and the second set of windings as a 6-phase motor, operating the first set of windings as a 3-phase motor in response to a detected abnormal operating condition affecting the second motor assembly, and operating the second set of windings as a 3-phase motor in response to a detected abnormal operating condition affecting the first motor assembly. In another aspect, the method further includes implementing a safe stop of the actuator using only the first motor assembly when an abnormal operating condition affecting the second motor assembly is detected.

In some embodiments, the invention features a method. The method includes determining, by at least one processor, a trajectory of a robot joint operably coupled to an actuator, based on the trajectory, determining an action to be performed for the robot joint to reach a safe state, storing the trajectory in association with the action in a storage, and in response to detection of an abnormal operating condition affecting an operation of the robot joint, controlling, by the at least one processor, the actuator to operate the robot joint in accordance with the action to reach the safe state.

In one aspect, the storage is associated with the robot joint, and wherein storing the trajectory in association with the action in the storage comprises sending the trajectory and the action to the storage associated with the robot joint. In another aspect, the at least one processor includes a first processor and a second processor, the first processor being configured to determine the trajectory of the robot joint, and the second processor being configured to control the actuator to operate the robot joint in accordance with the action to reach the safe state.

In some embodiments, the invention features a method. The method includes controlling an actuator coupled to a robot member to move the robot member about a robot joint using a motor controller, wherein the motor controller includes a first communication interface configured to receive one or more first control commands for controlling an operation of the actuator and a second communication interface configured to receive one or more second control commands for controlling an operation of the actuator when an abnormal operating condition is detected that affects communication via the first communication interface.

In one aspect, the method further includes receiving by at least one of the first communication interface or the second communication interface the one or more first control commands and the one or more second control commands wirelessly.

In some embodiments, the invention features a method. The method includes detecting an abnormal operating condition associated with a motor controller of a robot, the motor controller including a first set of components and a second set of components, each of the first set of components and the second set of components independently operable by the motor controller to control an actuator to move a robot member about a robot joint, determining whether the abnormal operating condition is associated with the first set of components or the second set of components, controlling the actuator to move the robot member about the robot joint using only the first set of components when it is determined that the abnormal operating condition is associated with the second set of components, and controlling the actuator to move the robot member about the robot joint using only the second set of components when it is determined that the abnormal operating condition is associated with the first set of components.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 illustrates an example configuration of a robotic device, according to an illustrative embodiment.

FIG. 2 illustrates a perspective view of a quadruped robot, according to an illustrative embodiment.

FIG. 3 illustrates a perspective view of a biped robot, according to an illustrative embodiment.

FIG. 4 illustrates an exemplary actuator having two stators sharing a common axis, according to an illustrative embodiment.

FIG. 5 illustrates an exemplary actuator having two sets of interleaved motor windings, according to an illustrative embodiment.

FIG. 6A illustrates a perspective view of an exemplary robot joint including an actuator with two motor assemblies, according to an illustrative embodiment.

FIG. 6B illustrates a half sectional view of an exemplary robot joint including an actuator with two motor assemblies, according to an illustrative embodiment.

FIG. 7 illustrates an exemplary electronic circuit for an actuator, according to an illustrative embodiment.

FIG. 8 illustrates an example control architecture for a robotic device, according to an illustrative embodiment.

FIG. 9 illustrates another exemplary electronic circuit for an actuator, according to an illustrative embodiment.

FIG. 10 illustrates another exemplary electronic circuit for an actuator, according to an illustrative embodiment.

FIG. 11 illustrates another exemplary electronic circuit for an actuator, according to an illustrative embodiment.

FIG. 12 is a flowchart of an exemplary method, according to an illustrative embodiment.

### DETAILED DESCRIPTION

An example implementation involves a robotic device configured with at least one robotic limb, one or more sensors, and a processing system. The robotic limb may be an articulated robotic appendage including a number of members connected by joints. The robotic limb may also include a number of actuators (e.g., 2-20 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, motor currents, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine motions or other parameters of the robotic device, e.g., the angles of the joints of the robotic limb (either directly from angle sensor information or indirectly from other sensor information from which the joint angles can be calculated).

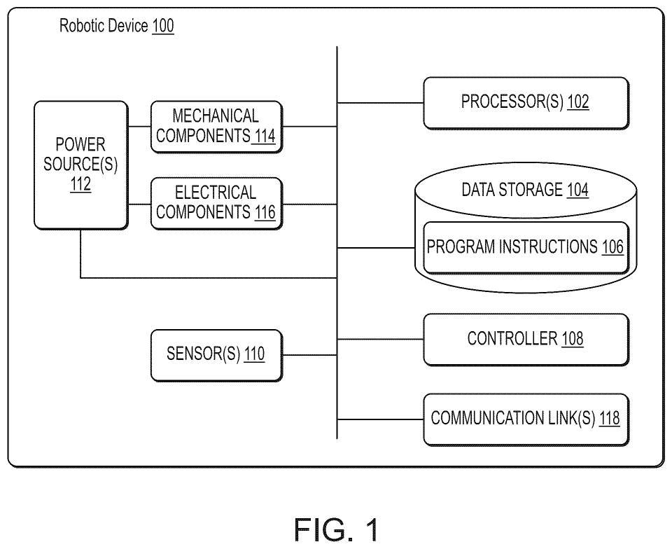

FIG. 1 illustrates an example configuration of a robotic device (or “robot”) 100, according to an illustrative embodiment. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, positional encoders, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), inertial measurement unit(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100 (e.g., electric components, such as electric motors and/or gearboxes may be used in place of or in addition to hydraulic components).

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

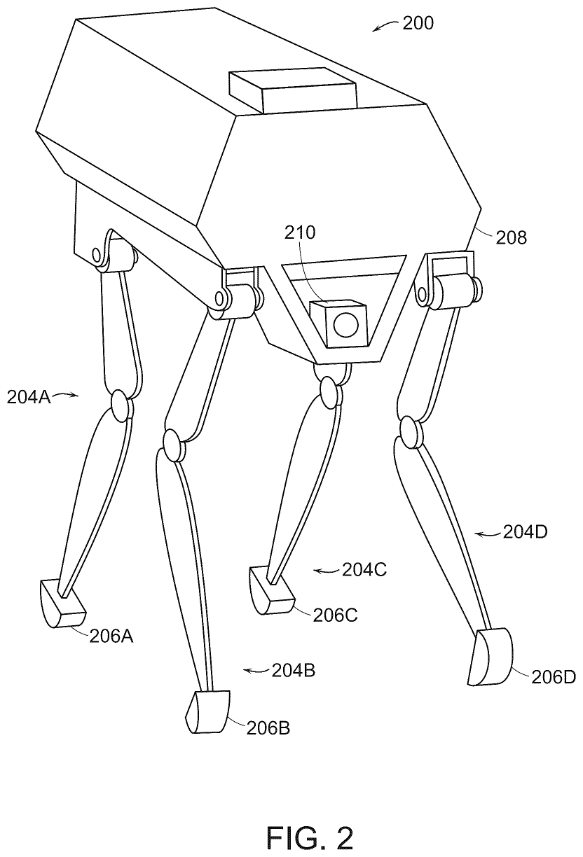

FIG. 2 illustrates a quadruped robot 200, according to an example implementation. Among other possible features, the robot 200 may be configured to perform some of the operations described herein. The robot 200 includes a control system, and legs 204A, 204B, 204C, 204D connected to a body 208. Each leg may include a respective foot 206A, 206B, 206C, 206D that may contact a surface (e.g., a ground surface). Further, the robot 200 is illustrated with sensor(s) 210, and may be capable of carrying a load on the body 208. Within other examples, the robot 200 may include more or fewer components, and thus may include components not shown in FIG. 2.

The robot 200 may be a physical representation of the robotic device 100 shown in FIG. 1, or may be based on other configurations. Thus, the robot 200 may include one or more of mechanical components 114, sensor(s) 110, power source(s) 112, electrical components 116, and/or controller 108, among other possible components or systems. In addition, the configuration, position, and/or structure of the legs 204A-204D may vary in example implementations. For example, the legs 204A-204D may enable the robot 200 to move relative to its environment, and may be configured to operate in multiple degrees of freedom to enable different techniques of travel. In particular, the legs 204A-204D may enable the robot 200 to travel at various speeds according to the mechanics set forth within different gaits. The robot 200 may use one or more gaits to travel within an environment, which may involve selecting a gait based on speed, terrain, the need to maneuver, and/or energy efficiency.

The body 208 of the robot 200, which may connect to the legs 204A-204D, may house various components of the robot 200. For example, the body 208 may include or carry sensor(s) 210. These sensors may be any of the sensors discussed in the context of sensor(s) 110, such as a camera, LIDAR, or an infrared sensor, but are not limited to those illustrated in FIG. 2. In addition, sensor(s) 210 may be positioned in various locations on the robot 200, such as on the body 208 and/or on one or more of the legs 204A-204D, among other examples.

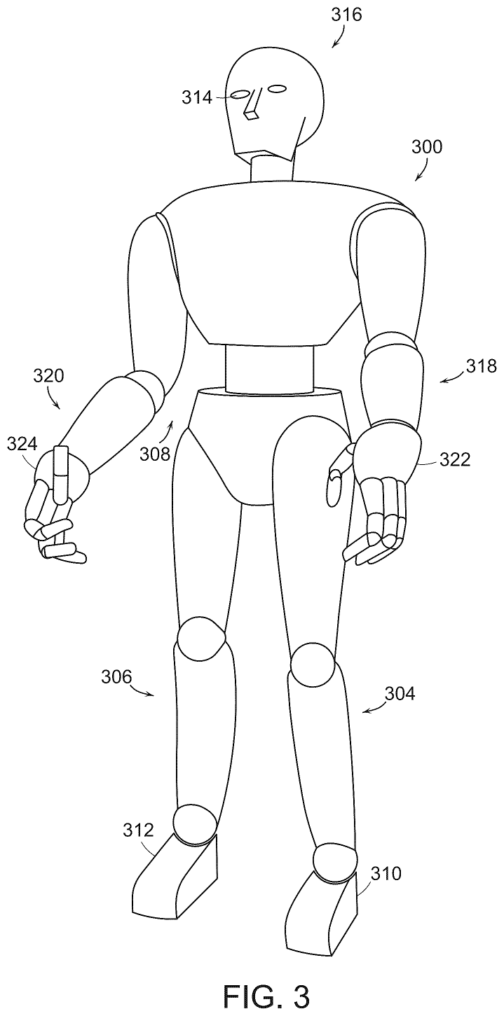

FIG. 3 illustrates a biped robot 300 according to another example implementation. Similar to robot 200, the robot 300 may correspond to the robotic device 100 shown in FIG. 1, and may be configured to perform some of the implementations described herein. Thus, like the robot 200, the robot 300 may include one or more of mechanical components 114, sensor(s) 110, power source(s) 112, electrical components 116, and/or controller 108.

For example, the robot 300 may include legs 304 and 306 connected to a body 308. Each leg may consist of one or more members connected by joints and configured to operate with various degrees of freedom with respect to one another. Each leg may also include a respective foot 310 and 312, which may contact a surface (e.g., a ground surface). Like the robot 200, the legs 304 and 306 may enable the robot 300 to travel at various speeds according to the mechanics set forth within gaits. The robot 300, however, may utilize different gaits from that of the robot 200, due at least in part to the differences between biped and quadruped capabilities.

The robot 300 may also include arms 318 and 320. These arms may facilitate certain functions for the robot 300, such as object manipulation, load carrying, and/or balancing. Like legs 304 and 306, each arm may consist of one or more members connected by joints and configured to operate with various degrees of freedom with respect to one another. Each arm may also include a respective hand 322 and 324. The robot 300 may use hands 322 and 324 for gripping, turning, pulling, and/or pushing objects. The hands 322 and 324 may include various types of appendages or attachments, such as fingers, grippers, welding tools, cutting tools, and so on.

The robot 300 may also include sensor(s) 314, corresponding to sensor(s) 110, and configured to provide sensor data to its control system. In some cases, the locations of these sensors may be chosen in order to suggest an anthropomorphic structure of the robot 300. Thus, as illustrated in FIG. 3, the robot 300 may contain vision sensors (e.g., cameras, infrared sensors, object sensors, range sensors, etc.) within its head 316.

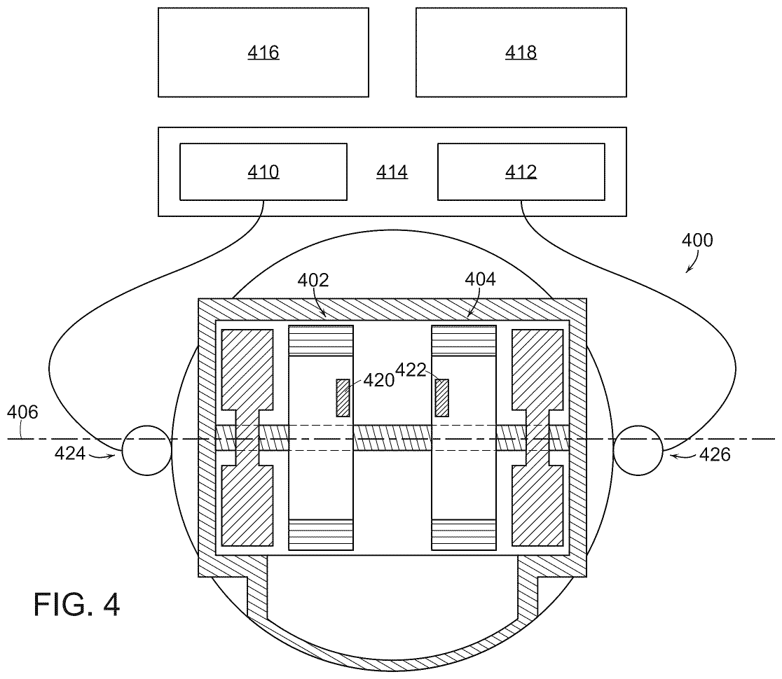

FIG. 4 illustrates an exemplary actuator 400 having two stators 402, 404 sharing a common axis 406, according to an illustrative embodiment. The first stator 402 is electrically connected to a first motor drive system 424, and the second stator 404 is electrically connected to a second motor drive system 426. The first motor drive system 424 is electrically connected to a first control circuit 410, and the second motor drive system 426 is electrically connected to a second control circuit 412. In some embodiments, the first control circuit 410 and the second control circuit 412 are mounted on a common power distribution board 414 (although the power distribution board 414 can also be compartmentalized, if desired, in cases in which failing to do so creates a significant failure risk). The first control circuit 410 is electrically connected to a first battery 416, and the second control circuit 412 is electrically connected to a second battery 418. In some embodiments, the first stator 402 has a first commutation encoder 420, and the second stator 404 has a second (e.g., independent) commutation encoder 422.

In FIG. 4, a substantial portion of the failure risk associated with actuator 400 is compartmentalized into two independently functional “half” assemblies, in which power is provided by two independent sources, motor driving and control functions are provided by two independent electronic mechanisms, and electrical wiring is provided via two independent electrical pathways. These two independent “half” assemblies may occupy approximately the same volume, and have approximately the same mass, as a single actuator without such compartmentalization of power and control functions.

In some embodiments, during normal operation, each “half” assembly may be responsible for approximately half of the torque command of the actuator 400. In other words, each “half” assembly may be configured to control the actuator 400 to produce approximately half of the torque needed to perform a particular action. In the event of an abnormal operating condition (e.g., any number of operational failure conditions), one of the two independent “half” assemblies may be compromised. For example, if any power connection breaks, one of the motor control circuits (e.g., the control circuit 410 or the control circuit 412) may power off, while the other motor control circuit may remain operational. In some embodiments, a larger system (e.g., a robot in which the actuator 400 is implemented), can detect this abnormal operating condition immediately and issue a safe stop command to all actuators in the robot. The remaining “half” assembly (i.e., the half assembly that still has power) can take control of the actuator 400 during a safe stop behavior. As another example, if an internal failure occurs to one of the commutation encoders 420, 422 (or one of the stators 402, 404, or another electrical component), the abnormal operating condition can be detected directly by the control circuits 410, 412 and the corresponding motor drive system 424, 426 may be disabled. In such an event, a controller of the larger system in which the actuator 400 is implemented (e.g., a robot) can be informed of the abnormal operating condition and control the robot to a safe stop.

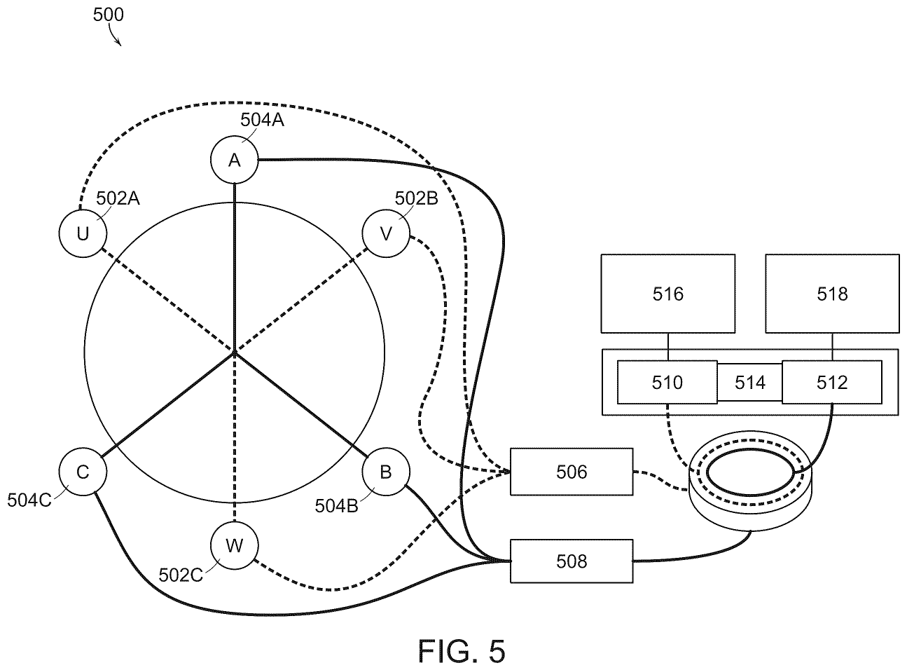

FIG. 5 illustrates an exemplary actuator 500 having two sets of interleaved motor windings 502, 504, according to an illustrative embodiment. The first set of motor windings 502A, 502B, 502C (e.g., corresponding to U, V, W) is interleaved with the second set of motor windings 504A, 504B, 504C (e.g., corresponding to A, B, C). The first set of motor windings 502 is electrically connected to a first motor drive system 506, and the second set of motor windings 504 is electrically connected to a second motor drive system 508. The first motor drive system 506 is electrically connected to a first control circuit 510, and the second motor drive system 508 is electrically connected to a second control circuit 512. In some embodiments, the first control circuit 510 and the second control circuit 512 are mounted on a common power distribution board 514 (although the power distribution board 514 can also be compartmentalized, if desired, in cases in which failing to do so creates a significant failure risk). The first control circuit 510 is electrically connected to a first battery 516, and the second control circuit 512 is electrically connected to a second battery 518.

In FIG. 5, the actuator 500 may include many of the same features as the actuator 400 shown and described in FIG. 4, except that the two motor stators are co-located on the same stator lamination stack. In FIG. 5, the windings may be considered to be organized as a 6-phase motor, but the actuator 500 is electrically connected and controlled as two redundant three-phase systems. During normal operation, the two sets of motor windings 502, 504, together with their associated electrical components, can operate as a single 6-phase motor. However, in the case that one of the sets of motor windings experiences an abnormal operating condition (e.g., a fault), the other set of motor windings can act as a single three-phase motor, which can provide some portion of torque (e.g., approximately half of the torque that the 6-phase motor provides). The same is true of other downstream electrical components, such as the motor drive systems 506, 508, the control circuits 510, 512, or the batteries 516, 518. At this point, the abnormal operating condition can be recognized, and a “safe stop” command issued to the actuator 500, which the actuator 500 can act upon using the remaining motor that is still able to function. In some embodiments, the “safe stop” command may be issued by a safety system of the larger robot. It should be appreciated that although a 6-phase motor is described, the techniques described herein may be used with any type of motor including, but not limited to, a 3-phase motor.

The inventors have recognized and appreciated that, in some instances, all power used to control one or more actuators of the robot may be lost, in which case the inclusion of redundant components in the control architecture for an actuator, as discussed herein, may be insufficient for the robot to reach a safe state, such as to facilitate a safe fall of the robot when the power is lost. To mitigate the risk of injury to the robot or other entities in the vicinity of the robot when such a power failure occurs, in some embodiments, one or more joints of the robot may be designed in a way to facilitate the slowing of movement of previously energized joints (e.g., due to inertia) so that the robot may fall in a desired footprint.

For example, in some embodiments, when an abnormal operation condition(s) is recognized that affects each set of motor windings for an actuator 500 of a robot, all power may be removed from the actuator 500, resulting in a corresponding joint of the robot that includes actuator 500 to fall or otherwise go “limp.” In some such embodiments, a “safe stop” command may result in power being removed from each of the actuators of the robot in response to recognition of such an abnormal operation condition(s). In response to power being removed from the actuators, the robot may be configured to fall within a desired footprint. In order to avoid potential hazards caused by the movement of the joints as the robot falls, the robot may include one or more free-spinning joints and/or damped joints. When power is removed from the actuator 500 (e.g., due to an abnormal operating condition(s)), the corresponding joint controlled by the actuator may fall or otherwise go “limp.” The speed/manner in which the joint falls or goes “limp” may be based on the configuration of the joint (e.g., whether the joint is configured to be free-spinning or passively damped). A free-spinning joint may correspond to a joint that is configured to rotate or move freely as the robot falls. A damped joint may correspond to a joint whose movement is passively slowed when power is removed from the joint due to a configuration of the joint. For example, a joint may be passively damped by inclusion of a viscoelastic material in the joint. In some embodiments, a damped joint may include brakes (e.g., mechanical brakes) configured to make contact with at least a portion of the joint when power is removed from the joint to slow motion at the joint. It should be appreciated that a robot designed in accordance with the techniques described herein may include any suitable set of free-spinning and/or damped joints including, but not limited to, a set of joints that only includes free-spinning joints, a set of joints that only includes damped joints, or a set of joints that includes a combination of free-spinning joints and damped joints.

In some embodiments, the “safe stop” command may include an action(s) performable by the actuator 500 to reach a safe state of the joint, such as a state where the joint does not pose a hazard to nearby objects or people. For example, in response to detection of an abnormal operating condition affecting an operation of actuator 500 (or the robot that includes actuator 500), the action(s) to be performed may be determined by a safety system of the robot and an indication of the action(s) to be performed may be included as part of the “safe stop” command issued to the actuator 500. In some embodiments, determining the action(s) to be performed may include retrieving the action(s) to be performed from a storage device in communication with the safety system of the robot. For example, the storage device may be configured to store the action(s) to be performed in association with a movement (e.g., trajectory) of the joint. When an abnormal operating condition is detected, the action(s) to be performed may be retrieved from storage based on the current trajectory of the joint. For example, during normal operation of the robot, the safety system of the robot may be configured to periodically determine a trajectory of one or more joints of the robot and store those trajectories in a storage device. A safety system of the robot may then determine an action(s) to be performed by actuators operating the joints to reach a safe state by accessing the stored trajectory information when needed. In some embodiments, the safety system may include a storage device for each joint/actuator of the robot. In the event that an abnormal operating condition is detected that affects an operation of an actuator(s) of the system, the action(s) to be performed may be retrieved from the corresponding storage device and included in “safe stop” command(s) issued to the corresponding actuators. In some embodiments, issuing the “safe stop” command including the action(s) to an actuator may comprise sending the “safe stop” command to a processor/microcontroller configured to control the actuator to operate the joint.

In some embodiments, a variable actuator configuration may be employed such that one or more joints of the robot may be configured to operate as a free-spinning joint under some conditions and operate as a damped joint under other conditions. For instance, information (e.g., pose and/or position information) associated with the robot when an abnormal operating condition is detected may be used, at least in part, to determine, the behavior of the joints in the set of joints to perform a safe stop. In some embodiments, the information associated with the robot may be determined based on a last known state of the robot. For example, the last known state of the robot may include information describing the weight distribution of the robot, joint velocities of robot and/or joint trajectories of the robot. In some embodiments, the position of the joints of the robot when an abnormal operating condition is detected may be determined based, at least in part, on an optimized cost function and/or as an output of a trained machine learning model (e.g., a reinforcement learning model).

When an abnormal operating condition of the robot is detected and a “safe stop” command is issued, a set of joints may be configured to operate as free-spinning joints or damped joints to enable the robot to reach a safe state (e.g., by collapsing to the ground within a desired (e.g., minimum) footprint). As an example, the back, hip, and/or ankle joints of a humanoid robot (e.g., the robot 300 shown and described above in FIG. 3) may be controlled as damped joints while the knee joints of the robot may be configured as free-spinning joints. In some instances, configuring joints such as knee joints to rotate quickly as free-spinning joints may allow for the rapid reduction in the overall potential energy of the robot, while the damping of the back, hip and/or ankle joints may provide continued stability for the robot as it falls. In some embodiments, the same joint may be configured to operate as a free-spinning joint over a first time period and/or as a damped joint over a second time period. For instance, knee joints of a humanoid robot may be configured to operate initially as free spinning joints to dissipate robot potential energy and later (i.e., after some delay) as damped joints to provide additional stability to the robot as it falls.

In some embodiments, one or more joints of the robot may be controlled during a “safe stop” such that one or more actuators regenerate sufficient energy (e.g., via the rotation of the magnetic motor across its stator windings) to self power (e.g., the motor driver circuitry), thereby providing fall control for the robot even in the event of system level power loss to the robot.

In some embodiments, one or more portions (e.g., limbs) of the robot may have their own power switching circuitry such that a portion of the robot may be electrically disconnected from the other portions of the robot. For example, a failed joint in an arm (or other portion) of a robot may have a failure mode (e.g., a short circuit) that may propagate throughout the robot and prevent proper allocations of damping and free-spinning joints in accordance with the techniques described herein. By electrically isolating the arm (or other portion) of the robot via its power switching circuitry, the fault may be contained within a portion of the robot having the failed joint. Additionally, the inclusion of limb-based power switching circuitry to electrically isolate individual limbs of a robot may enable the remaining limbs (i.e., limbs not having a failed joint) to remain powered to permit a more controlled transition of the robot into a safe state. In some embodiments, each limb of the robot may include its own power switching circuitry that may be controlled to electrically isolate the limb when an abnormal operating condition associated with the limb is detected. For instance, with reference to the biped robot 300 shown in FIG. 3, each of legs 304 and 306 and each of arms 318 and 320 may include its own power switching circuitry. Other unlabeled portions of biped robot 300 including, but not limited, to the robot's head, neck, torso, or pelvis may also include its own power switching circuitry, which may be controlled to electrically isolate the portion of the robot when an abnormal operating condition of the robot is detected within the corresponding portion.

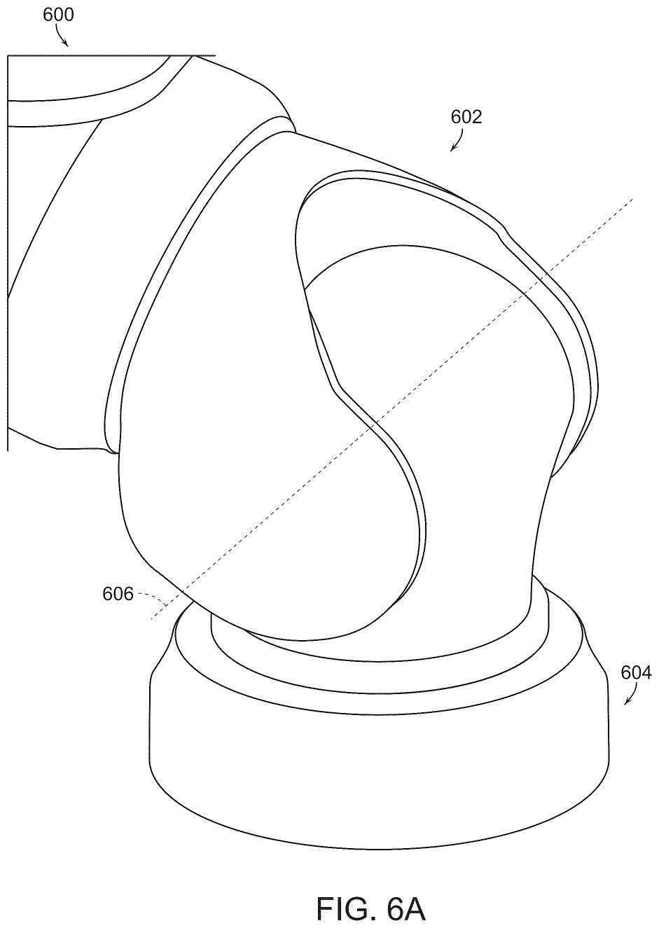

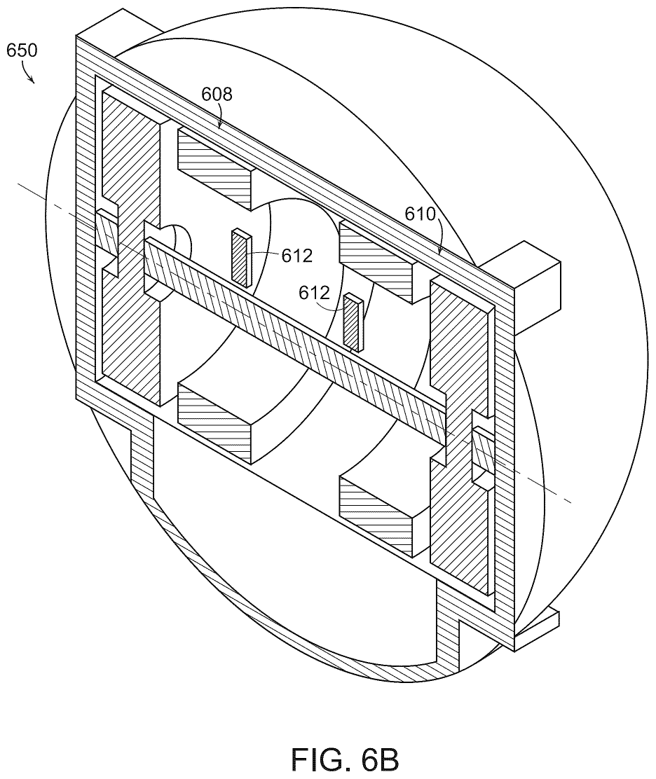

FIG. 6A illustrates a perspective view of an exemplary robot joint 600 including an actuator with two motor assemblies, according to an illustrative embodiment. The robot joint 600 shown is a knee joint for a humanoid robot (e.g., the robot 300 shown and described above in FIG. 3), but one having ordinary skill in the art will readily appreciate that a similar mechanism could be used for other kinds of robotic joints. In FIG. 6A, the robot joint 600 provides an interface for an upper leg member 602 to rotate with respect to a lower leg member 604 around knee rotation axis 606.

FIG. 6B illustrates a half sectional isometric view of an exemplary robot joint 650 (e.g., robot joint 600 shown in FIG. 6A) including an actuator (e.g., actuator 400 discussed with respect to FIG. 4). The actuator may include two stators 608, 610 and two encoders 612, 614 (e.g., two commutation encoders), according to an illustrative embodiment.

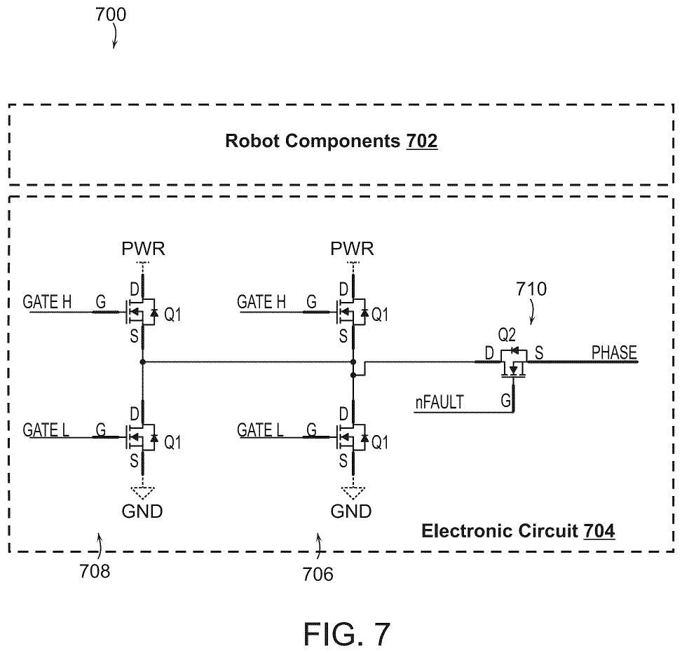

FIG. 7 illustrates an exemplary electronic circuit 704 for an actuator (e.g., the actuator 400 shown and described above in FIG. 4), according to an illustrative embodiment. For instance, one or more electronic circuits 704 may be included within first control circuit 410 and/or second control circuit 412. In some embodiments, a duplication of electronic circuit 704 is included in the electrical path coupling a motor controller to each phase of a multiple-phase motor (e.g., a 6-phase motor as described herein). The electronic circuit 704 is electrically connected to the robot components 702 included in the robot 700. The robot components 702 may include electronic components (e.g., some or all of those shown and described above). During operation, current flows from the robot components 702 to the electronic circuit 704. The electronic circuit 704 may include one or more switching devices (e.g., Field-Effect Transistors (FETs) such as GaN FETs or MOSFETs, Insulated-Gate Bipolar Transistors (IGBTs), etc.) configured to control an amount of current received from the robot components 702 that is provided to energize electrical windings for a phase of a motor. For example, as shown in FIG. 7, the electronic circuit 704 may include a first gate drive circuitry 706 configured to control (e.g., via switching) an amount of current provided as output of electronic circuit 704. The electronic circuit 704 may further include a second gate drive circuitry 708 also configured to control (e.g., via switching) an amount of current provided as output electronic circuit 704.

In the event of an abnormal operating condition occurring that affects operation of one, but not both, of the gate drive circuitries 706, 708, the other gate drive circuitry may be used to continue to control the amount of current provided as output of the electronic circuit 704. For example, in the event of an abnormal operating condition occurring that affects the operation of the first gate drive circuitry 706, operation of the first gate drive circuitry 706 may cease, and the second gate drive circuitry 708 may be used to control the amount of current output from electronic circuit 704.

As shown in FIG. 7, electronic circuit 704 may also include an additional switching device 710 (e.g., an additional FET) arranged between the output of the first and second gate drive circuitry 706, 708 architectures and an output of the electronic circuit 704. Switching device 710 may be configured to isolate the components of electronic circuit 704 and upstream electronics in robot components 702 in the event of an abnormal operating condition of the robot resulting in a “half” assembly in which electronic circuit 704 is included fails. For example, in normal operation, the switching device 710 may be configured to permit current to flow from the output node of the first gate drive circuitry 706 and the second gate drive circuitry 708 to a phase of the stator(s), effectively allowing the robot components 702 to control operation of the actuator. In the event of an abnormal operating condition occurring that affects operation of the robot components 702 and/or the stator(s), the switching device 710 may disconnect the first and second gate drive circuitries 706, 708 from the phase of the stator to protect those components (and upstream robot components 702) from damage (e.g., due to back electromotive force (EMF) generated when the remaining “half” assembly continues to operate.

In some embodiments, the electronic circuit 704 may operate to selectively control the connection between the robot components 702 and motor windings associated with a stator(s) of the actuator. For example, as discussed herein, in some embodiments, the actuator may include two sets of interleaved motor windings configured as a 6-phase motor. In some embodiments, the switching device 710 may be configured to couple or electrically disconnect an output node of the first gate drive circuitry 706 and the second gate drive circuitry from a first motor winding (e.g., corresponding to a first stator phase) in a first set of motor windings. The inclusion of switching device 710 in electronic circuit 704 in accordance with some embodiments may mitigate phase-to-phase shorts on either operative side of the electronic circuit 704 (e.g., shorts effecting/occurring in the stator and/or the robot components 702). In some such embodiments, each phase of the stator of the actuator may be connected to the robot components 702 using an electronic circuit similar to the electronic circuit 704.

In some embodiments, the electrical connection between the robot components 702 and the each of the stator-phases may be disconnected, such as when an abnormal operating condition affecting the stator is detected. For example, in some instances, an abnormal operating condition affecting a stator may effectively short stator phases together, which may impact a force control of a joint controlled by the actuator. For example, a stator with shorted phases may cause a torque that resists the control torque from the remaining motor. As such, in some embodiments, in the event that an abnormal operating condition is detected that affects a stator, each of the stator phases electrically connected to the robot components 702 may be electrically disconnected.

In some embodiments, the electronic circuit 704 may include an additional switching device (not shown in FIG. 7) that provides redundancy for switching device 710. The additional switching device may be configured similarly to the switching device 710.

As discussed herein, in some embodiments, the actuator may be split into functional “half” assemblies, each of which may include an independent motor drive system, control circuit, battery, encoder, etc. and may be responsible for approximately half of the torque command of the actuator. In some embodiments, in the event that an abnormal operating condition is detected that affects (at least one component of) one “half” assembly of the actuator, the electronic circuit 704 may be configured to electrically disconnect the corresponding “half” assembly of the actuator, without affecting the connection between the remaining “half” assembly of the actuator. For example, the switching device 710 may operate as discussed herein to disable the flow of current between an output node of the first gate drive circuitry 706 and the second gate drive 708 and the stator(s). The remaining “half” assembly can take control of the actuator to provide the remaining half toque command and to implement a safe stop behavior, as discussed herein.

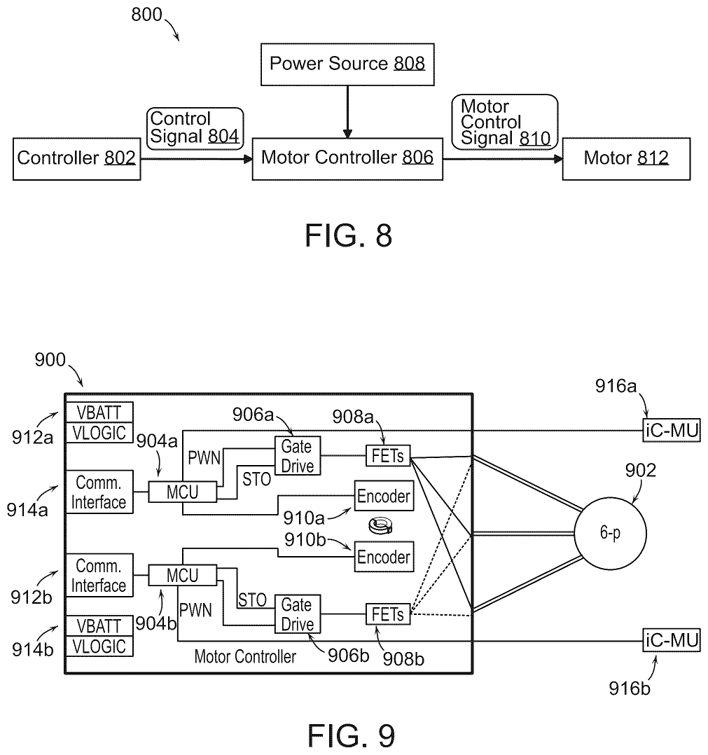

FIG. 8 illustrates an example control architecture 800 for controlling an actuator of a robotic device, in accordance with some embodiments of the present invention. Control architecture 800 may include a controller 802 (e.g., one or more hardware computer processors) configured to provide a control signal 804 to a motor controller 806. The controller 802 may be a component of a robot, such as the robot 200 or the robot 300, and may be configured to monitor and/or control operations of the robot, such as movement of joints of the robot, by generating control signals representing an operation to be performed by joints of the robot. The motor controller 806 may be configured to control operation of an actuator for a robot joint of the robot based on the control signal 804 received from the controller 802. The motor controller 806 may interpret the control signal 804, representing an operation to be performed by a robot joint, and generate electrical signals used to control an actuator of the robot joint to operate according to the control signal 804. The motor controller 806 may control the actuator of the robot joint by driving one or more motor windings of motor 812 with a current from power source 808, wherein the current output from motor controller 806 may be represented as motor control signal 810.

FIG. 9 illustrates another exemplary electronic circuit for an actuator, according to an illustrative embodiment. FIG. 9 shows a motor controller 900 electrically connected to a motor 902, such as a 6-phase motor, and including a set of redundant components for controlling operations of the motor 902. The motor controller 900 may include a first set of components, such as a first communication interface 914a, a first microcontroller 904a, a first gate drive circuitry 906a, first switching device(s) 908a, and a first commutation encoder 910a. The first communication interface 914a is electrically connected to the first microcontroller 904a, which is electrically connected to the first gate drive circuitry 906a, the first commutation encoder 910a, and a first positional encoder 916a. The first gate drive circuitry 906a may be electrically connected to the first switching device(s) 908a and may be configured to control an amount of current provided from first power source 912a to a first set of phases of motor 902. In some embodiments, first gate drive circuitry 906a may be electrically connected to first power source 912a by a first power lead (not shown). In some embodiments, the first power lead may be coupled to a wiring interconnect, non-limiting examples of which include a slip ring or a clockspring. The first set of components may be configured to control operation of the motor 902 by providing half of a torque command during normal operation of the motor 902. The motor controller 900 may further include a second set of components, such as a second communication interface 914b, a second microcontroller 904b, a second gate drive circuitry 906b, a second switching device(s) 908b, and a second commutation encoder 910b. The second communication interface 914b is electrically connected to the second microcontroller 904b. The second microcontroller 904b is electrically connected to the second gate drive circuitry 906b, the second commutation encoder 910b, and a second positional encoder 916b. The second gate drive circuitry 906b is electrically connected to a second switching device(s) 908b and may be configured to control an amount of current provided from second power source 912b to a second set of phases of motor 902. In some embodiments, second gate drive circuitry 906a may be electrically connected to second power source 912b by a second power lead (not shown). In some embodiments, the second power lead may be coupled to a wiring interconnect, non-limiting examples of which include a slip ring or a clockspring. The second set of components may be configured to control operation of the motor 902 by providing half of a torque command during normal operation of the motor 902. In some embodiments, the second communication interface 914b, the second microcontroller 904b, the second gate drive circuitry 906b, the second switching device(s) 908b, and the second commutation encoder 910b may be configured similar to the first communication interface 914a, the first microcontroller 904a, the first gate drive circuitry 906a, the first switching device(s) 908a, and the first commutation encoder 910a to control the motor 902, independent of the first set of components. As such, the first set of components and the second set of components may be considered redundant in that each provides half of the torque command to the motor during normal operation, and one of the two sets of components can continue to operate when the other set of components is compromised (e.g., due to a fault or other abnormal operating condition).

The first communication interface 914a and the second communication interface 914b may be configured to receive control signals (e.g., from controller 802 in control architecture 800) for controlling the motor 902. In some embodiments, the communication interfaces may be configured as a network switch (e.g., an Ethernet switch, a wireless network switch). The first microcontroller 904a and the second microcontroller 904b of the motor controller 900 may be configured to interpret the control signals received via the respective communication interfaces and provide a signal to the first gate drive circuitry 906a and the second gate drive circuitry 906b, respectively, to operate the motor 902 according to the received control signals. The first power source 912a and the second power source 912b may provide current to one or more of the components of the motor controller 900. For example, the first gate drive circuitry 906a and the second gate drive circuitry 906b may be configured to receive a current from the first power source 912a and the second power source 912b, respectively, and provide the current to the motor 902, such as via the first switching device(s) 908a and the second switching device(s) 908b, respectively. In some embodiments, the signal received by the gate drive circuitries from the microcontrollers may indicate an amount of current to be provided to the motor 902. The first switching device(s) 908a and the second switching device(s) 908b may be configured to enable/disable the flow of current from the first gate drive circuitry 906a and the second gate drive circuitry 906b, respectively, to the motor 902. Such control may be implemented, at least partially, using an electronic circuit such as electronic circuit 704 described in connection with FIG. 7. In some embodiments, the signal received by the gate drive circuitries from the microcontrollers may be a switching signal for the switching devices to enable/disable the flow of current to the motor 902. The first commutation encoder 910a and the second commutation encoder 910b may be configured to process position information received by the first microcontroller 904a and the second microcontroller 904b from the first positional encoder 916a, and the second positional encoder 916b, respectively, to determine a commutation output(s) based on a rotation/position of the motor 902, which may be used by the microcontrollers to determine an amount of current to be provided to the motor 902 to drive the motor 902 according to the control signal.

In some embodiments, as discussed above, each of the first set of components and the second set of components may be configured to independently generate a signal for controlling the motor 902 to produce half of a desired amount of torque needed for the actuator to perform a particular action. Each of the first set of components and second set of components may be configured, therefore, to continue to generate a corresponding signal in the event that an abnormal operating condition is detected that affects (operations of) the other set of components. As such, in the event that an abnormal operating condition is detected that affects one or more of the components of the first set of components (e.g., the first communication interface 914a, the first microcontroller 904a, the first gate drive circuitry 906a, the first switching device(s) 908a, and/or the first commutation encoder 910a), the operations of the first set of components may be ceased, and the operations of the second set of components may continue to generate a signal for controlling the motor 902 with half of the total commanded torque. Providing half of the commanded torque may be sufficient to enable the actuator to execute a safe stop.

Having redundant sets of components that are independently controllable may allow the motor controller 900 to continue to drive operation of motor 902 even in the situation where the operation of one set of components is compromised. For example, if an abnormal operating condition is detected that affects the first communication interface 914a, then operations using the first set of components (e.g., such as those performed by the first microcontroller 904a, the first gate drive circuitry 906a, the first switching device(s) 908a, and/or the first commutation encoder 910a) may be ceased, without affecting the operations of the second set of components. As a further example, if an abnormal operating condition is detected that affects the first microcontroller 904a, then operations using the first set of components (e.g., the first gate drive circuitry 906a, the first switching device(s) 908a, and/or the first commutation encoder 910a) may be ceased, without affecting the operations of the second set of components. As another example, if an abnormal operating condition is detected that affects the first commutation encoder 910a, then operations using the first set of components (e.g., the first gate drive circuitry 906a and/or the first switching device(s) 908a) may be ceased, without affecting the operations of the second set of components.

As described in connection with electronic circuit 704 in FIG. 7, ceasing operation of the first set of components or the second set of components without electrically disconnecting that set of components from the motor 902 may result in an undesirable condition. For example, the ceased set of components, if not electrically disconnected from the motor, may experience back EMF from the motor 902, which may damage electrical components in the ceased set of components and/or upstream electrical components (e.g., an electrically connected power source). In some embodiments, to prevent such an undesirable condition from occurring, a ceased or disabled set of components (e.g., the first set of components or the second set of components) may be electrically disconnected from the motor 902 (e.g., using one or more switching devices 710), in response to detecting an abnormal operating condition that affects that set of components. In some embodiments, ceasing the first set of components may further include the first microcontroller 904a sending a signal (e.g., a Safe Torque Off (STO) signal) to the first gate drive circuitry 906a to control the first switching device(s) 908a to electrically disconnect motor 902, without affecting the operations of the second set of components.

In some embodiments, the first switching device(s) 908a and the second switching device(s) 908b may include more than one switching device. As discussed above, in some embodiments, an assembly may include a switching device for each stator phase of the motor 902, such that the switching device may be further configured to control the flow of current from the motor controller 900 to a particular stator phase of the motor 902 in the event that an abnormal operating condition is detected that affects the stator phase of the motor 902. For example, the first switching device(s) 908a may include three switching devices configured to control the flow of current to three stator phases of the motor 902, and the second switching device(s) 908b may include three switching devices configured to control the flow of current to three other stator phases of the motor 902.

In some embodiments, each set of components may be electrically connected to one or more stator phases of the motor 902. For example, as shown in FIG. 9, the first set of components is electrically connected to three stator-phases of the motor 902, e.g., via three different switching devices of the first switching device(s) 908a. As such, the first switching device(s) 908a may be configured to enable/disable the flow of current from the motor controller 900 to a particular stator phase of the motor 902 in the event that an abnormal operating condition is detected that affects the stator phase of the motor 902. Additionally, the second set of components is electrically connected to another three stator-phases of the motor 902, e.g., via three different switching devices of the second switching device(s) 908b. As such, the second switching device(s) 908b may be configured to enable/disable the flow of current from the motor controller 900 to a particular stator phase of the motor 902 in the event that an abnormal operating condition is detected that affects the stator phase of the motor 902. As such, although the motor 902 is organized as a 6-phase motor, the motor 902 may be capable of functioning as a 3-phase motor in the event that an abnormal operating condition is detected that affects the operation of one of (the components of) the first set of components or the second set of components.

In some embodiments, the motor controller 900 may be electrically connected to a redundant pair of positional encoders, such as the first positional encoder 916a and the second positional encoder 916b. Specifically, the first positional encoder 916a may be electrically connected to the first microcontroller 904a and the second positional encoder 916b may be electrically connected to the second microcontroller 904b. In some such embodiments, ceasing of the operations of the first set of components or the second set of components may be further in response to detection of an abnormal operating condition occurring that affects the first positional encoder 916a or the second positional encoder 916b, respectively. As such, ceasing of the operation of one set of components may not affect the operations of the positional encoder electrically connected to the other set of components.

In some embodiments, the motor controller 900 may be configured to provide a wide, dynamic range of signals to the motor 902. In some instances, power provided to the motor 902 to produce an amount of torque needed for an actuator to perform an action may be considerably less than the maximum amount of power that the motor controller 900 is capable of providing to the motor 902. In some such instances, less than all of the redundant components of the motor controller 900 may be needed to properly drive the motor 902 during normal operation. As such, the motor controller 900 may be configured to only use the components needed to provide the amount of power for properly driving the motor 902. Such a configuration of the motor controller 900 may result in more efficient use of power by the motor controller 900. For example, when the motor 902 is being controlled to perform actions that do not require more than half the maximum amount of torque command that may be provided by the motor 902, only a single set of the redundant sets of components (e.g., the first set of components or the second set of components) may be used to provide the desired torque command to the motor 902. In some embodiments, a single set of components may be used to operate the motor 902 by default, where the additional set of components may be enabled or otherwise additionally used to provide torque command to the motor when required to perform a particular action.

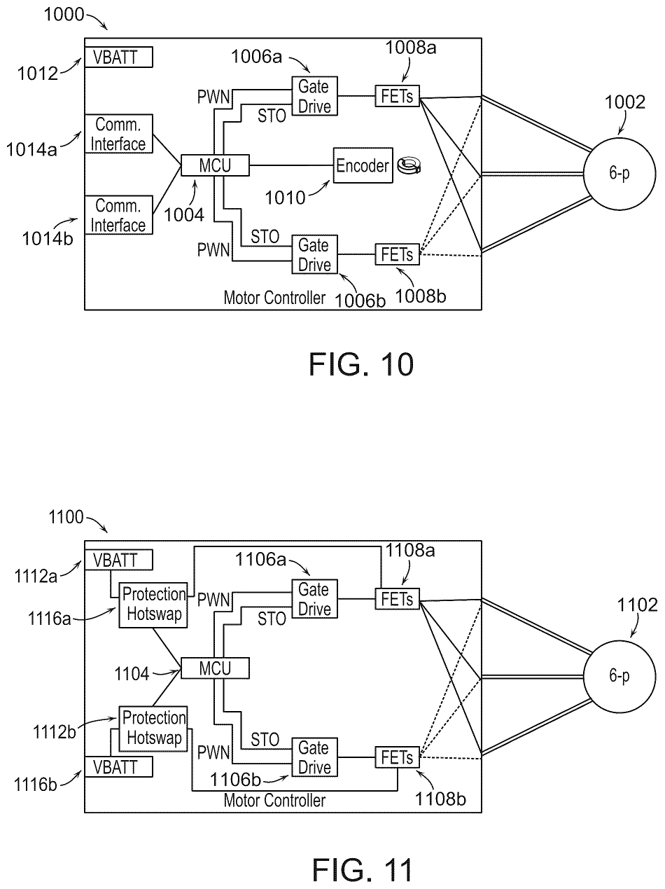

FIG. 10 illustrates another exemplary electronic circuit for an actuator, according to an illustrative embodiment. In the example shown in FIG. 10, both of a first communication interface 1014a and a second communication interface 1014b are electrically connected to the microcontroller 1004. Additionally, the microcontroller 1004 is electrically connected to a commutation encoder 1010, a first gate drive circuitry 1006a and a second gate drive circuitry 1006b. The second gate drive circuitry 1006b is electrically connected to a second switching device(s) 1008b, which is in electronic communication with a power source 1012 and a motor 1002. As such, FIG. 10 displays additional details of a specific implementation where the motor controller 1000 includes redundant communication interfaces, gate drive circuitries, and switching devices. Including the redundant communication interfaces in the motor controller 1000 may allow, in the event that an abnormal operating condition is detected that affects one of the communication interfaces, the motor controller 1000 to cease use of the affected communication interface and continue its operations using the remaining communication interface.

Each of the redundant pairs of gate drive circuitries and switching device(s) may be configured to independently control the motor 1002 to produce half of a maximum amount of torque needed for the actuator to perform a particular action. In response to detecting an abnormal operating condition affecting the first gate drive circuitry 1006a and/or the first switching device(s) 1008a, control of the motor 1002 using the first gate drive circuitry 1006a and the first switching device(s) 1008a may be ceased, by, for example, ceasing operation of the first gate drive circuitry 1006a and/or the first switching device(s) 1008a, without affecting the control of the motor 1002 using the second gate drive circuitry 1006b and/or the second switching device(s) 1008b, and vice versa.

As discussed herein, in some embodiments, ceasing control of the motor 1002 using the first gate drive circuitry 1006a and the first switching device(s) 1008a, in response to detecting an abnormal operating condition has occurred that affects the first gate drive circuitry 1006a and/or the first switching device(s) 1008a, may further include the microcontroller 1004 sending a signal (e.g., a STO signal) to the first gate drive circuitry 1006a to control the first switching device(s) 1008a to disable the flow of current from the first switching device(s) 1008a to the motor 1002, without affecting the control of the motor 1002 using the second gate drive circuitry 1006b and the second switching device(s) 1008b.

As also discussed herein, each switching device(s) may be electrically connected to one or more phases of the motor 1002 via one or more motor windings. For example, as shown in FIG. 10, the first switching device(s) 1008a is electrically connected to three stator-phases of the motor 1002 via a first set of motor windings. Additionally, the second switching device(s) 1008b is electrically connected to another three stator-phases of the motor 1002 via a second set of motor windings. As such, although the motor 1002 is organized as a 6-phase motor, the first set of motor windings or the second set of motor windings of the motor 1002 may be capable of functioning as a 3-phase motor in the event that an abnormal operating condition is detected that affects the operation of one of the first switching device(s) 1008a or the second switching device(s) 1008b, respectively. As discussed herein, the motor controller 1000 may include a switching device for each phase of the motor 1002, such that the switching device may be further configured to disable the flow of current from the motor controller 1000 to a particular stator phase of the motor 1002 in the event that an abnormal operating condition is detected that affects the stator phase of the motor 1002 and/or a component electrically connected to the stator phase of the motor 1002.

FIG. 11 illustrates another exemplary electronic circuit for an actuator, according to an illustrative embodiment. FIG. 11 shows a motor controller 1100 configured to receive current from a first power source 1112a. Motor controller 1100 includes a first protection hotswap component 1116a electrically coupled between the current input from first power source 1112a and a first switching device(s) 1008a. FIG. 11 further shows motor controller 1100 is configured to receive current from a second power source 1112b. Motor controller 1100 includes a second protection hotswap component 1116b electrically coupled between the current input from second power source 1112b and a second switching device(s) 1108b. In some embodiments, the first power source 1112a and the second power source 1112b may provide current from separate power sources (e.g., separate batteries). In other embodiments, the first power source 1112a and the second power source 1112b may provide current from separate portions, subsets, or partitions of the same power source (e.g., the same battery or battery pack). In some embodiments, the motor controller 1100 may include a commutation encoder (not illustrated), which may be configured similar to the commutation encoders 910a, 910b, 1010 discussed herein in connection with FIGS. 9 and 10.

As discussed herein, each of the redundant pairs of gate drive circuitries and switching device(s) may be configured to independently control the motor 1102 to produce half of a maximum amount of torque needed for the actuator to perform a particular action. As such, in response to detecting an abnormal operating condition affecting the first gate drive circuitry 1106a and/or the first switching device(s) 1108a, control of the motor 1102 using the first gate drive circuitry 1106a and the first switching device(s) 1108a may be ceased, such as by ceasing operation of the first gate drive circuitry 1106a and/or the first switching device(s) 1108a, without affecting the control of the motor 1102 using the second gate drive circuitry 1106b and/or the second switching device(s) 1108b.

As discussed herein, in some embodiments, ceasing control of the motor 1102 using the first gate drive circuitry 1106a and the first switching device(s) 1108a, in response to detecting an abnormal operating condition has occurred that affects the first gate drive circuitry 1106a and/or the first switching device(s) 1108a, may further include the microcontroller 1104 sending a signal (e.g., a STO signal) to the first gate drive circuitry 1106a to control the first switching device(s) 1108a to disable the flow of current from the first switching device(s) 1108a to the motor 1102, without affecting the control of the motor 1102 using the second gate drive circuitry 1106b and the second switching device(s) 1108b.

In some embodiments, the first power source 1112a and the second power source 1112b may be configured for providing approximately half of the current required to produce a particular amount of torque by the motor 1102. The protection hotswap components (e.g., the first protection hotswap component 1116a and the second protection hotswap component 1116b) may be configured to detect an abnormal operating condition that affects one of the power sources (e.g., the first power source 1112a or the second power source 1112b) and effectively disconnects the power source from the corresponding switching device(s) (e.g., the first switching device(s) 1108a or the second switching device(s) 1108b), thereby electrically isolating the power source from the other components of the motor controller 1100. Isolating a power source determined to be affected by a detected abnormal operating condition may not affect the operation of the other power source of the motor controller 1100. As such, the remaining power source may continue to provide current to the corresponding switching device(s) and, therefore, the motor 1102. For example, in response to the first protection hotswap component 1116a detecting that an abnormal operating condition has occurred that affects the first power source 1112a, the first protection hotswap component 1116a may disconnect the flow of current from the first power source 1112a to the first switching device(s) 1108a, without affecting the flow of current from the second power source 1112b to the second switching device(s) 1108b.

In some embodiments, in addition to isolating a power source determined to be affected by an abnormal operating condition, the corresponding switching device may electrically disconnect the motor controller 1100 from (one or more phases of) the motor 1102, without affecting the operation of the other switching device. For example, in response to the first protection hotswap component 1116a detecting that an abnormal operating condition has occurred that affects the first power source 1112a, the first protection hotswap component 1116a may disconnect the flow of current from the first power source 1112a to the first switching device(s) 1108a, and the first switching device(s) 1108a may further electrically disconnect the motor controller 1100 from (the one or more phases of) the motor 1102, without affecting the electrical connection between the motor controller 1100 and (one or more other phases of) the motor 1102 that is maintained by the second switching device(s) 1108b.

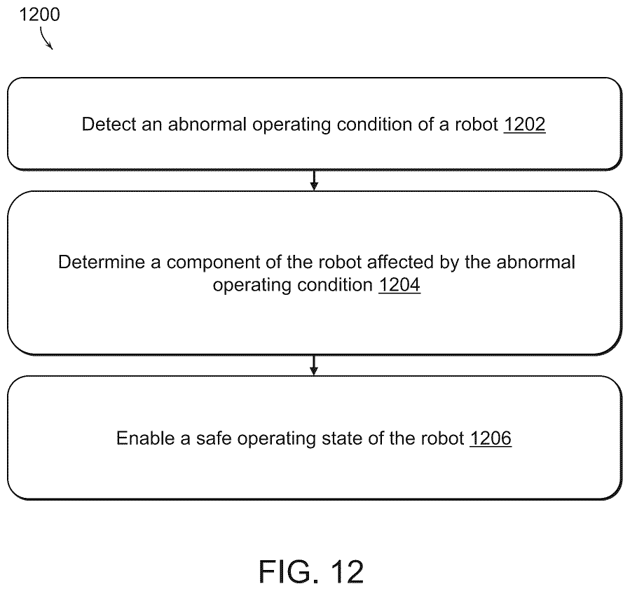

FIG. 12 is a flowchart of an exemplary method 1200, according to an illustrative embodiment. Method 1200 begins in act 1202, where an abnormal operating condition (e.g., a fault) associated with a motor controller of a robot is detected. The motor controller may include a first set of components and a second set of components, each of which is independently operable by the motor controller to control an actuator to move a robot member about a robot joint. Method 1200 then proceeds to act 1204, where it is determined whether the detected abnormal operating condition is associated with the first set of components. If it is determined in act 1206 that the detected abnormal operating condition is associated with the first set of components, method 1200 proceeds to act 1208, where the actuator is controlled to move the robot member about the robot joint using only the second set of components. If it is determined in act 1206 that the abnormal operating condition is not associated with the first set of components, method 1200 proceeds to act 1210, where the actuator is controlled to move the robot member about the robot joint using only the first set of components.

As used herein, an “electrical connection” or a component that is “electrically connected” to at least one other component (also referred to herein as “electrical communication” or “electronic communication”) may correspond to a connection between two or more components that may be connected or disconnected by another component of the system.

A number of implementations have been described. Nevertheless, it will be understood that various modifications may be made without departing from the spirit and scope of the disclosure.

1. An actuator comprising:
a housing;
a first motor assembly at least partially disposed within the housing, the first motor assembly electrically connected to a first power lead and a first control data interface; and
a second motor assembly at least partially disposed within the housing, the second motor assembly electrically connected to a second power lead and a second control data interface,
wherein the first motor assembly and the second motor assembly are each independently operable to drive movement of the actuator.

2. The actuator of claim 1, wherein the first power lead is electrically connected to a first power source and the second power lead is electrically connected to a second power source, the first power source separate from the second power source.

3. The actuator of claim 2, further comprising:
at least one first switch configured to isolate the first power source from the first motor assembly in response to detecting an abnormal operating condition affecting the first motor assembly; and
at least one second switch configured to isolate the second power source from the second motor assembly in response to detecting an abnormal operating condition affecting the second motor assembly.

4. The actuator of claim 2, wherein the first power source is electrically connected to a first power bus and the second power source is electrically connected to a second power bus, the first power bus separate from the second power bus.

5. The actuator of claim 1, wherein:
at least one of the first power lead or the first control data interface is electrically connected to a first wiring interconnect; and
at least one of the second power lead or the second control data interface is electrically connected to a second wiring interconnect.

6. The actuator of claim 5, wherein the first wiring interconnect is a first slip ring and the second wiring interconnect is a second slip ring.

7. The actuator of claim 1, wherein the first control data interface is electrically connected to a first control circuit and the second control data interface is electrically connected to a second control circuit, the first control circuit separate from the second control circuit.

8. The actuator of claim 1, wherein the first motor assembly comprises a first commutation encoder and the second motor assembly comprises a second commutation encoder.

9. The actuator of claim 1, wherein the first motor assembly is electrically connected to a first motor drive system and the second motor assembly is electrically connected to a second motor drive system.

10. The actuator of claim 9, further comprising a first switching device electrically connected to the first motor assembly and a second switching device electrically connected to the second motor assembly, wherein:
(i) the first switching device is configured to disconnect the first motor assembly from the first motor drive system when an abnormal operating condition affecting the first motor assembly is detected, and
(ii) the second switching device is configured to disconnect the second motor assembly from the second motor drive system when an abnormal operating condition affecting the second motor assembly is detected.

11. The actuator of claim 1, wherein the first motor assembly comprises a first stator and the second motor assembly comprises a second stator, the first stator and the second stator sharing a common axis.

12. The actuator of claim 1, wherein the first motor assembly comprises a first set of windings and the second motor assembly comprises a second set of windings, the first set of windings interleaved with the second set of windings around a common axis.

13. The actuator of claim 12, wherein:
the first set of windings and the second set of windings operate as a 6-phase motor,
the first set of windings is configured to operate as a 3-phase motor in response to a detected abnormal operating condition affecting the second motor assembly, and
the second set of windings is configured to operate as a 3-phase motor in response to a detected abnormal operating condition affecting the first motor assembly.

14. The actuator of claim 1, wherein the actuator is configured to implement a safe stop using only the first motor assembly when an abnormal operating condition affecting the second motor assembly is detected.

15. The actuator of claim 1, wherein the first motor assembly and the second motor assembly are operably connected to a common drive shaft.

16. The actuator of claim 1, wherein the first motor assembly and the second motor assembly are operably connected to a robot joint.

17. The actuator of claim 16, wherein the robot joint is configured to spin freely when an abnormal operating condition affecting at least one of the first motor assembly or the second motor assembly is detected.

18. The actuator of claim 16, wherein:
the robot joint includes a viscoelastic material, and
a movement of the robot joint is configured to be slowed based on the viscoelastic material in response to detecting an abnormal operating condition affecting at least one of the first motor assembly or the second motor assembly.

19.-24. (canceled)

25. A robot comprising:
an actuator coupled to a robot member; and
a motor controller configured to control the actuator to move the robot member about a robot joint, wherein:
the motor controller includes a first set of components and a second set of components, and
each of the first set of components and the second set of components is independently operable by the motor controller to control the actuator to move the robot member about the robot joint.

26.-52. (canceled)

53. A method comprising:
detecting an abnormal operating condition associated with a motor controller of a robot, the motor controller including a first set of components and a second set of components, each of the first set of components and the second set of components independently operable by the motor controller to control an actuator to move a robot member about a robot joint;
determining whether the abnormal operating condition is associated with the first set of components or the second set of components;
controlling the actuator to move the robot member about the robot joint using only the first set of components when it is determined that the abnormal operating condition is associated with the second set of components; and
controlling the actuator to move the robot member about the robot joint using only the second set of components when it is determined that the abnormal operating condition is associated with the first set of components.
